(19) United States
(12) Patent Application Publication
(10) Pub. No.: US 2014/0167702 A1
(43) Pub. Date: Jun. 19, 2014

(54) CHARGING AND DISCHARGING CONTROL CIRCUIT AND BATTERY DEVICE

(71) Applicant: Seiko Instruments Inc., Chiba-shi (JP)

(72) Inventors: Atsushi SAKURAI, Chiba-shi (JP); Kazuaki SANO, Chiba-shi (JP); Toshiyuki KOIKE, Chiba-shi (JP); Shinya FUKUCHI, Chiba-shi (JP)

(73) Assignee: Seiko Instruments Inc., Chiba-shi (JP)

(21) Appl. No.: 14/106,122

(22) Filed: Dec. 13, 2013

(30) Foreign Application Priority Data
Dec. 17, 2012 (JP) 2012-274510

(51) Int. Cl. H02J 7/00

(52) U.S. Cl. CPC H02J 7/0029
USPC 320/134

(57) ABSTRACT

There are provided an overcurrent protection circuit which has a smaller circuit area, a charging and discharging control circuit, and a compact battery device. The charging and discharging control circuit includes an overcurrent detection circuit which monitors the voltage of an overcurrent detection resistor connected to an overcurrent detection terminal and which detects the flow of an overcurrent into a secondary battery, an overcurrent release circuit which monitors the voltage at a terminal to which a load is connected through a voltage step-down circuit connected to an overcurrent release terminal and which detects the removal of a load, and a clamping circuit connected to the overcurrent release terminal are provided. The voltage at the overcurrent release terminal is clamped by the voltage step-down circuit and the clamping circuit.

### RELATED APPLICATIONS

This application claims priority under 35 U.S.C. §119 to Japanese Patent Application No. 2012-274510 filed on Dec. 17, 2012, the entire content of which is hereby incorporated by reference.

### BACKGROUND OF THE INVENTION

1. Technical Field

The present invention relates to a charging and discharging control circuit that detects the voltage or a failure of a secondary battery and a battery device and relates particularly to an overcurrent protection circuit thereof.

2. Background Information

A battery device is mainly used as a power source for a portable electronic device. The battery device is provided with an overcurrent protection function for protecting a circuit from an overcurrent if the current supplied to an electronic device, i.e., a load, increases and exceeds a maximum current (refer to, for example, Patent Document 1).

FIG. 3 is a block diagram of a battery device provided with an overcurrent protection circuit. A conventional battery device 1 has a charging and discharging control circuit 2, a battery 3 comprised of a plurality of secondary batteries connected in series, a switch circuit 4, and an overcurrent detection resistor 5. The charging and discharging control circuit 2 has a control circuit 20, an overcurrent control circuit 21, an overcurrent detection comparator 22, and a reference voltage circuit 23. The overcurrent control circuit 21 has an overcurrent release comparator 24, a reference voltage circuit 25, and a pull-down circuit 26.

The foregoing battery device 1 operates as described below to protect the circuits from an overcurrent.

A voltage proportional to a current between +VO terminal and −VO terminal appears at the overcurrent detection resistor 5. If the current between the +VO terminal and the −VO terminal increases, the overcurrent detection comparator 22 detects the overcurrent by the voltage at a terminal Ml and issues a detection signal to the control circuit 20. The control circuit 20 is placed in an overcurrent detection mode and turns off the switch circuit 4 through a terminal DO thereby to cut off the current. The overcurrent control circuit 21 monitors the voltage at the −VO terminal by a terminal M2. When it is detected that a load has been disconnected from the battery device 1, the overcurrent control circuit 21 clears the overcurrent detection mode of the control circuit 20.

[Patent Document 1] Japanese Patent Application Laid-Open No. 2002-238173.

However, in the foregoing charging and discharging control circuit 2, when the switch circuit 4 is turned off upon the detection of an overcurrent, the voltage at the terminal M2 increases to a level in the vicinity of the voltage at the +VO terminal. Thus, the terminal M2 and the overcurrent control circuit 21 have been required to have configurations that survive such an increase in the voltage, resulting in a large circuit area.

Further, if a higher voltage is required of the battery 3, then a plurality of charging and discharging control circuits 2 is required to be vertically stacked and connected. However, only one charging and discharging control circuit 2 has the overcurrent detection resistor 5 connected thereto so as to detect an overcurrent. This means that the remaining charging and discharging control circuits 2 have been provided with unnecessary overcurrent protection circuits, resulting in the wasteful circuit area thereof.

### SUMMARY OF THE INVENTION

The present invention has been made with a view toward solving the problem described above and provides a charging and discharging control circuit with a smaller circuit area and a compact battery device.

To solve the problem with the prior art, the charging and discharging control circuit in accordance with the present invention is configured as described below.

The charging and discharging control circuit includes: an overcurrent detection circuit which monitors a voltage of an overcurrent detection resistor connected to an overcurrent detection terminal and which detects an overcurrent flowing into a secondary battery; an overcurrent release circuit which monitors a voltage at a terminal to which a load is connected through a voltage step-down circuit connected to an overcurrent release terminal and which detects disconnection of a load; and a clamping circuit connected to the overcurrent release terminal, wherein the voltage at the overcurrent release terminal is clamped by the voltage step-down circuit and the clamping circuit.

According to the charging and discharging control circuit of the present invention, the withstand voltages of the terminals and the overcurrent control circuit may be lower, so that the circuit area can be reduced. This makes it possible to provide a charging and discharging control circuit with a smaller circuit area and a compact battery device.

### BRIEF DESCRIPTION OF THE DRAWINGS

FIG. 1 is a block diagram of a battery device provided with an overcurrent protection circuit according to an embodiment;

FIG. 2 is a block diagram of a semiconductor device provided with the overcurrent protection circuit according to the embodiment; and

FIG. 3 is a bock diagram of a battery device provided with a conventional overcurrent protection circuit.

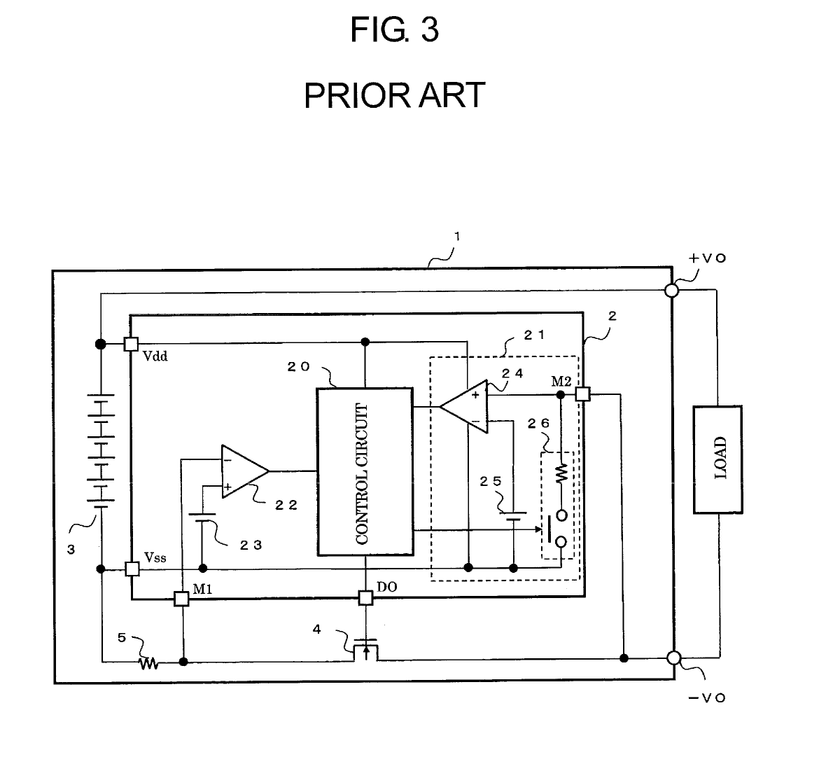

### DETAILED DESCRIPTION OF THE PREFERRED EMBODIMENTS

An embodiment of the present invention will be described with reference to the accompanying drawings.

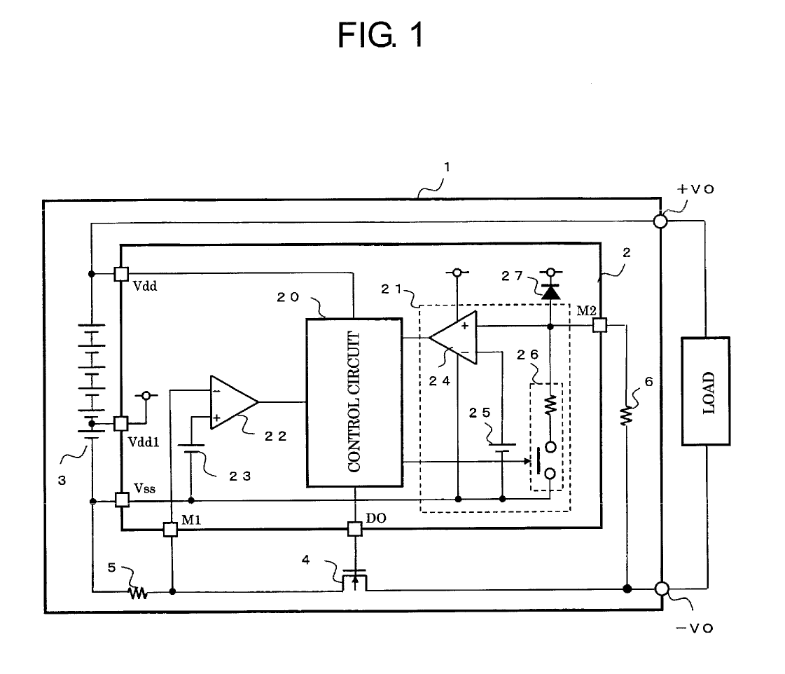

FIG. 1 is a block diagram of a battery device that includes an overcurrent protection circuit.

A battery device 1 according to the present embodiment includes a charging and discharging control circuit 2, a battery 3 comprised of a plurality of secondary batteries connected in series, a switch circuit 4, an overcurrent detection resistor 5, and a voltage step-down circuit 6. The charging and discharging control circuit 2 includes a control circuit 20, an overcurrent control circuit 21, an overcurrent detection comparator 22, a reference voltage circuit 23, and a clamping circuit 27. The overcurrent control circuit 21 includes an overcurrent release comparator 24, a reference voltage circuit 25, and a pull-down circuit 26.

The battery device 1 drives a load connected between +VO terminal and −VO terminal by the voltage of the battery 3. The charging and discharging control circuit 2 monitors the voltage of the battery 3 connected to a supply terminal Vdd and a supply terminal Vss. If an over discharge occurs, the charging and discharging control circuit 2 carries out control, such as turning off the switch circuit 4 through a terminal DO to stop the discharge.

The foregoing battery device 1 operates as described below to protect the circuits from an overcurrent.

A voltage proportional to a current between the +VO terminal and the −VO terminal appears at the overcurrent detection resistor 5. If the current between the +VO terminal and the −VO terminal increases, the overcurrent detection comparator 22 detects the overcurrent by the voltage at a terminal M1 and issues a detection signal to the control circuit 20. The control circuit 20 is placed in an overcurrent detection mode upon the receipt of the detection signal from the overcurrent detection comparator 22 and turns off the switch circuit 4 through the terminal DO thereby to cut off the current. The overcurrent control circuit 21 monitors the voltage at the −VO terminal by a terminal M2. When it is detected that the load has been disconnected from the battery device 1, the overcurrent control circuit 21 clears the overcurrent detection mode of the control circuit 20.

When the switch circuit 4 is turned off, the voltage at the −VO terminal increases to a level in the vicinity of the voltage at the +VO terminal. However, the voltage step-down circuit 6 is connected between the −VO terminal and the terminal M2, and the clamping circuit 27 is provided in the terminal M2. Thus, the voltage at the terminal M2 causes the current to flow from the battery 3 through the intermediary of the +VO terminal, the load, the −VO terminal, the voltage step-down circuit 6, the terminal M2, the clamping circuit 27, and a supply terminal Vdd1 in this order. Hence, the effect of the voltage step-down circuit 6 prevents the voltage at the terminal M2 from increasing to a level in the vicinity of the voltage at the +VO terminal. In other words, the voltage at the terminal M2 is clamped at a level in the vicinity of the voltage at the supply terminal Vdd1 by the clamping circuit 27.

Accordingly, the terminal M2 and the overcurrent control circuit 21 are required only to have a withstand voltage approximately equivalent to, for example, the voltage of one secondary battery, thus permitting a reduced area of circuits, including the protection circuit of the terminal M2.

The clamping circuit 27 in the present embodiment is composed of a diode connected to the supply terminal Vdd1, whereas the clamping circuit 27 is not limited thereto. For example, a plurality of diodes, which are connected in series, may be connected to the supply terminal Vss.

Further, the overcurrent control circuit 21 in the present embodiment is configured to monitor the voltage at the terminal M2 by the overcurrent release comparator 24, whereas the overcurrent control circuit 21 is not limited to the circuit configuration. For example, an inverter may be used to monitor the voltage at the terminal M2.

Further, although the voltage step-down circuit 6 in the present embodiment is configured by a resistor, the configuration is not limited thereto. For example, the resistor may be replaced by an NMOS transistor having the gate thereof connected to the supply terminal Vdd1.

If a higher voltage is required of the battery 3, then a plurality of the charging and discharging control circuits 2 has to be vertically stacked and connected. In this case, there is only one charging and discharging control circuit 2 to which the overcurrent detection resistor 5 is connected and which detects an overcurrent, so that the remaining charging and discharging control circuits 2 vertically stacked and connected do not require the overcurrent protection circuits.

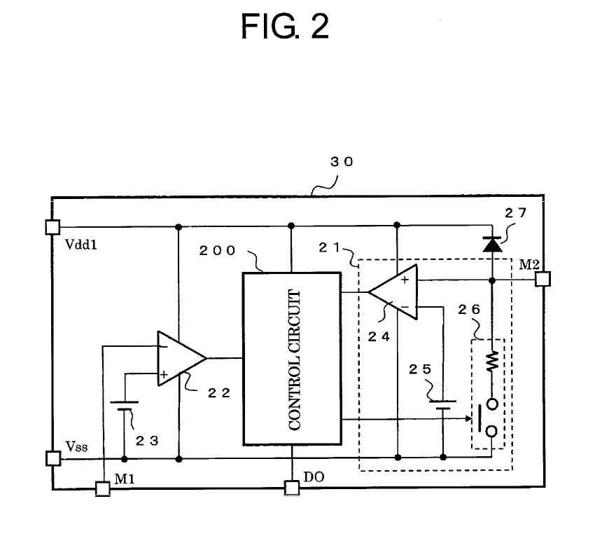

Accordingly, one overcurrent protection circuit 30 as illustrated in FIG. 2 may be provided in the battery device 1, thus eliminating the overcurrent protection circuits from the plurality of the charging and discharging control circuits 2 vertically stacked and connected.

The overcurrent protection circuit 30 includes a control circuit 200, an overcurrent control circuit 21, an overcurrent detection comparator 22, a reference voltage circuit 23, and a clamping circuit 27. The overcurrent control circuit 21 includes an overcurrent release comparator 24, a reference voltage circuit 25, and a pull-down circuit 26.

The operation of the overcurrent protection circuit 30 is the same as that of the overcurrent protection circuit of the charging and discharging control circuit 2 in FIG. 1. However, a communication terminal is additionally required, because a switch circuit 4 has to be controlled upon receipt of over discharge detection signals or the like of the plurality of charging and discharging control circuits 2 vertically stacked and connected, and the control circuit 200 is also required to have a function therefor.

As described above, according to the present invention, the withstand voltages of terminals and the overcurrent control circuit can be reduced, so that the circuit area can be reduced. This makes it possible to provide a charging and discharging control circuit having a smaller circuit area and a compact battery device.

Further, an overcurrent protection circuit is configured as a single semiconductor device, thus eliminating the overcurrent protection circuit from the charging and discharging control circuit 2. Hence, a more compact battery device can be provided.

What is claimed is:

1. A charging and discharging control circuit which monitors a voltage of a secondary battery and controls charging and discharging of the secondary battery, the charging and discharging control circuit comprising:
an overcurrent detection circuit which monitors a voltage of an overcurrent detection resistor connected to an overcurrent detection terminal and which detects a flow of an overcurrent into the secondary battery;
an overcurrent release circuit which monitors a voltage at a terminal to which a load is connected through a voltage step-down circuit connected to an overcurrent release terminal and which detects disconnection of the load; and
a clamping circuit connected to the overcurrent release terminal,
wherein a voltage at the overcurrent release terminal is clamped by the voltage step-down circuit and the clamping circuit.

2. The charging and discharging control circuit according to claim 1, wherein the clamping circuit is constituted of a diode connected between the overcurrent release terminal and a supply terminal.

3. A battery device comprising:
a plurality of secondary batteries connected in series;
the charging and discharging control circuit according to claim 1 connected in parallel to the secondary batteries;
the overcurrent detection resistor and a switch circuit connected in series between the secondary batteries and an external terminal; and
the voltage step-down circuit connected between the external terminal and the overcurrent release terminal.
